(19) United States
(12) Patent Application Publication
(10) Pub. No.: US 2005/0226986 A1
(43) Pub. Date: Oct. 13, 2005

(54) Method of producing a heat stable oil-in-water emulsion and the products made therefrom

(75) Inventors: Joseph Pinski, Falcon Heights, MN (US); Bill Fox, Shoreview, MN (US)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(73) Assignee: Land O'Lakes, Arden Hills, MN (US)

(21) Appl. No.: 11/150,976

(22) Filed: Jun. 13, 2005

Related U.S. Application Data
(63) Continuation-in-part of application No. 10/823,480, filed on Apr. 13, 2004.

(51) Int. Cl. A23C 15/00

(52) U.S. Cl. 426/581

(57) ABSTRACT

A method of forming a heat stable oil-in-water emulsion comprises providing a selected amount of an aqueous component comprising more than 50 weight percent water. The aqueous component is optionally heated and a selected amount of a solids component is added to the aqueous component under agitation to form a first intermediate. A selected amount of a milk fat containing component is heated to a temperature sufficient to predominantly melt the fat prior to being to the first intermediate to form a second intermediate. The second intermediate is optionally heated for a selected period of time. The second intermediate is homogenized at between about 250 psig and 5000 psig to form the heat stable oil-in-water emulsion comprising at least 20 weight percent milk fat. The second intermediate may be heated to between about 130° F. and 150° F. for a selected period of time. The second intermediate is homogenized at between about 250 psig and 5000 psig to form a third intermediate oil-in-water emulsion comprising at least 20 weight percent fat. A selected amount of shear sensitive component is added to the third intermediate to form the heat stable oil-in-water emulsion on the present invention.

### CROSS REFERENCE TO RELATED APPLICATIONS

This application is a continuation-in-part of U.S. patent Ser. No. 10/823,480, filed on Apr. 13, 2004 which is hereby incorporated by reference in its entirety.

### BACKGROUND OF THE INVENTION

The present invention relates to a food composition and method of producing the food composition. More particularly the present invention relates to a base for a food sauce or a completed food sauce both of which contain shear sensitive ingredients and a method of making the base for the food sauce or the food sauce containing the shear sensitive ingredients.

Food sauces such as hollandaise sauce and alfredo sauce are typically made to meet demand at full service restaurants. What is meant by food sauce is a sauce having as principle ingredients edible fat or oil, water and solids in an oil-in-water emulsion where the fat or oil may be added separately, or as a component of any ingredient having fat or oil as a component. Many of the preferred sauces are dairy based food sauces. What is meant by dairy based food sauce is a sauce having as principle ingredients milk fat, water and solids in an oil-in-water emulsion where milk fat may be added separately, or as a component of cream, milk, half & half, butter milk solids, butter or any other ingredient having milk fat as a component. What is meant by fat is an edible lipid or blend containing lipids having sufficient solid fat to resist flowing at room temperature. What is meant by oil is an edible lipid or blend containing lipids having sufficient liquid fat to be fluid (flow at room temperature). Edible lipids or lipid blends, being difficult to classify as resisting flow or fluid at room temperature, are included in either the term fat or the term oil.

Full service restaurants spend a significant amount of time and skilled labor preparing the food sauces. The food sauces require the correct oil-in-water emulsion having a high volume of the dispersed oil component in the continuous water component to be satisfactory to the diners.

Achieving the desired oil-in-water emulsion with the selected high volume of the fat or oil component requires experimentation and skill. Even after developing a standardized recipe there is no guarantee of success because the oil-in-water emulsion may invert and become a water-in-oil emulsion which is unsatisfactory to diners. When a batch of the dairy based sauce is unacceptable, additional time is required to meet the demand for the sauce, potentially causing stress on the restaurant staff and unnecessary delay to the diner.

Many of the preferred food sauces are not temperature stable. Therefore, large, made from scratch batches of the food sauce cannot be pre-made for use throughout a dining period. Furthermore, when the food sauce is cycled between ambient temperature and a refrigerated temperature, many food sauces have a tendency of “churning out”. What is meant by churning out is an emulsion inversion where the sauce becomes a water-in-oil emulsion where a portion of the water separates from the emulsion. Furthermore, when the food sauces are cycled between a refrigerated temperature or ambient temperature and an elevated cooking temperature the sauces have a tendency of coalescing or “creaming”. By creaming is meant the separation of oil from the water phase where the fat floats on the emulsion. Furthermore, many restaurant food sauces do not exhibit freeze-thaw stability. What is meant by freeze-thaw stability is that when the food sauces are frozen, the food sauce becomes unusable due to churning out, creaming, or complete breakdown of the food sauce emulsion into a discrete aqueous phase and a discrete fat component containing phase. Therefore a full service restaurant has to expend a significant amount of time and resources to produce the food sauces on demand to satisfy its customer's food selections.

### SUMMARY OF THE INVENTION

The present invention includes a method of forming a heat stable oil-in-water emulsion containing shear sensitive ingredients. The method includes providing a selected amount of an aqueous component comprising at least 30 weight percent water. A selected amount of a solids component is added to the aqueous component under agitation to form a first intermediate. A selected amount of a fat containing component is heated to melt the fat and is added to the first intermediate to form a second intermediate. The second intermediate may be heated to between about 130° F. and 150° F. for a selected period of time. The second intermediate is homogenized at between about 250 psig and 5000 psig to form a third intermediate oil-in-water emulsion comprising at least 20 weight percent fat. A selected amount of shear sensitive component is added to the third intermediate to form the heat stable oil-in-water emulsion on the present invention.

### DETAILED DESCRIPTION OF THE PREFERRED EMBODIMENTS

The present invention includes a heat stable oil-in-water emulsion that may be used as a base for a dairy based food sauce or a ready to use completed dairy based sauce. The oil-in-water emulsion and completed sauces therefrom are useful in the food service industry and particularly in a full service restaurant. The present invention also includes a method of producing the heat stable oil-in-water emulsion that may be used as a base for a variety of dairy based sauces, such as, but not limited to, an alfredo sauce, a hollandaise sauce, a Buerre blanc and a heavy cream sauce.

The heat stable oil-in-water emulsion includes an oil phase that is emulsified within a continuous water phase made up of an aqueous component. Suitable aqueous components include, but are not limited to, water-containing solutions or emulsions or suspensions or solutions or slurries. Often, the aqueous component may have emulsifiers added thereto, such as lecithin, Polysorbate 60, or Complemix 100, or proteins, such as aqueous components comprising milk, liquid buttermilk, cream, concentrated milk, concentrated cream. Alternative components suitably optionally included in an aqueous component include, but are not limited to, solutions of plant proteins, such as soy proteins or other oilseed proteins; cocoa proteins, vegetable proteins; powdered buttermilk; milk protein concentrates; and hydrolyzates of any of these. Other suitable aqueous components include oil-in-water emulsions made by rehydrating dried dairy products. Aqueous components may optionally be cultured with a suitable food-grade organism. The emulsion preferably has a greater percentage of an oil phase compared to a water phase on a weight percentage basis.

The oil phase or fat containing component, such as milk fat, contributes between about 20 weight percent and 70 weight percent of the total weight of the oil-in-water emulsion. Preferably, the oil component contributes between about 30 weight percent and 55 weight percent of the total weight of the emulsion. The oil phase or fat containing component is provided as a fluid fat containing component which may be obtained by using oil, such as vegetable oil or a liquid fraction of a fractionated milk fat, or by providing sufficient heat to a fat containing component, such as lard, milk fat, butter or hydrogenated vegetable oil, to melt a sufficient amount of the fat containing component so that the fat containing component becomes fluid. The fat containing component may include emulsifiers, including but not limited to lecithin, mono glycerides, diglycerides, and mixtures of these.

Water is primarily provided in the emulsion with a cream component that also contributes milk fat to the oil component. What is meant by cream is an oil-in-water emulsion containing from about 18 weight percent fat to about 96 weight percent fat dispersed in an aqueous component. Suitable types of oil-in-water emulsions include, but are not limited to, dairy-based creams such as cream, milk, half & half, and oil-in-water emulsions made by rehydrating dried dairy powders or any other ingredient having milk fat as a component. Other suitable creams include oil-in-water emulsions having other edible fats and oils, such as but not limited to soybean oil, palm oil, hydrogenated oils, anhydrous milkfat, and interesterified oils, dispersed in an aqueous component. Depending upon the ingredients used to contribute to the oil component, water may be directly added as an ingredient as needed to provide the desired oil-in-water emulsion. One skilled in the art will also recognize that fat, water and solids can be combined in desired ratios to produce a mixture which has the same composition and physical properties as the aqueous component.

The heat stable oil-in-water emulsion is preferably produced with the aqueous component having about 40 weight percent fat, about 53 weight percent water, about 2.2 weight percent protein, about 2.2 weight percent lactose and about 0.35 weight percent minerals and salt. The aqueous component contributes between about 10 and 90 weight percent of the total weight of the base and preferably between about 30 weight percent and 85 weight percent of the total weight of the base. Although an aqueous component having about 40 weight percent milk fat is preferred, any aqueous component having more than 18 weight percent fat is within the scope of the present invention. It is also within the scope of the present invention to manufacture an equivalent to the aqueous component by mixing water, solids and a fat containing component to create a desired aqueous component with a selected weight percent solids and fat.

Depending upon the oil content required for the oil-in-water emulsion, additional fat may be added through the addition of a fat containing component. An exemplary fat containing component is an anhydrous milk fat that is substantially 100 weight percent milk fat which may be added in a range of between about 5 weight percent and about 20 weight percent of the total weight of the oil-in-water emulsion. Alternatively, the milk fat containing component may be added with other dairy based ingredients containing milk fat such as butter. A typical composition of butter includes 80 weight percent milk fat, 16 weight percent water, 0.85 weight percent protein, 0.06 weight percent lactose, 2.11 weight percent ash and about 1 weight percent salt.

Another exemplary fat containing composition comprises vegetable oil or fat such as soybean oil or palm oil; hydrogenated oil, interesterified oil, fractionated oil. In order to increase the fat concentration of the oil-in-water emulsions the fat containing component must have a greater weight percent fat than the aqueous or cream component.

The heat stable oil-in-water emulsion also may contain solids including proteins that may be contained within both the oil phase and the water phase. Suitable solids include materials containing non-fat dry milk, buttermilk solids, milk protein concentrates, dried whey, whey protein concentrates, whey protein isolates, soy proteins, soy protein isolates, cocoa powder, defatted cocoa powder, cheese, or any other form of protein-containing solids. Additional solids are optionally added to the oil-in-water emulsion to increase the body, the viscosity, the thickness and improve the mouthfeel of the base. The amount of solids is determined on a solids non-fat basis (SNF) by the following formula where each of the concentrations is a weight percent of the total weight of the oil-in-water emulsion.

$$SNF = \frac{( protein + carbohydrate + minerals )}{( water + protein + carbohydrate + minerals )} \times 100$$

The solids non-fat may reach up to 24 weight percent of the total weight of the emulsion prior to the addition of shear sensitive ingredients such as cheese. However, at elevated concentrations, the SNF concentrations may make the emulsion dry, pasty and gummy at refrigerated temperatures prior to the addition of shear sensitive ingredients such as cheese.

Exemplary ingredient used to increase the solids in the oil-in-water emulsion is a buttermilk solids component, whey protein concentrate or a fat substitute such as Simplesse® fat substitute manufactured by CP Kelco, Inc. of Atlanta, Ga. The buttermilk solids component preferably contributes between about 3 and 10 weight percent of the total weight of the oil-in-water emulsion. The buttermilk powder typically consists of about 49 weight percent carbohydrate, about 34 weight percent protein, about 6 weight percent fat, about 3 weight percent moisture and about 8 weight percent ash and salt. An exemplary buttermilk powder is Land O'Lakes Dry Buttermilk Extra Grade, manufactured by Land O'Lakes of Arden Hills, Minn.

The heat stable oil-in-water emulsion also contains emulsifiers. Water-soluble emulsifiers may be added to the aqueous component, the first intermediate, or the second intermediate, and fat-soluble emulsifiers may be added to the fat containing component. Alternatively, suitable emulsifiers may be added to more than one component or intermediate. A suitable water-soluble emulsifier is Polysorbate 60, and a suitable fat-soluble emulsifier is lecithin.

Upon obtaining the desired ratios of oil to water and solids to water and/or oil, the mixture is homogenized to create a heat stable oil-in-water emulsion. The oil-in-water emulsion, which preferably includes a greater weight percent of the oil phase in the water phase and the desired solids content, provides a food sauce base that is heat stable and that has the organoleptic properties of a made from scratch diary based sauce. What is meant by heat stable is the ability to be cycled from refrigerated temperature or ambient temperature to cooking temperature and back without churning out or creaming. Churning out is the separation of fat during mechanical agitation, and creaming is the separation of fat from an emulsion either during mechanical agitation or in a static state. The oil-in-water emulsion preferably also exhibits freeze-that stability. What is meant by freeze-thaw stability is the ability to be cycled from ambient temperature to about 25° F. and back without churning out or creaming.

Besides water, fat and solids, other non-essential ingredients may also be added such as stabilizers. A non-exhaustive list of stabilizers and emulsifiers includes polysorbate, lecithin, beta carotene (also added for color), sodium benzoate, potassium sorbate, and Complemix 100. The emulsifiers are added to aid in emulsifying the oil component into the water component and to impart thermal stability. The stabilizers are optionally added to maintain the stability of the oil-in-water emulsion.

Enhancing ingredients are added to the mixture to enhance the flavor, texture, or appearance of the base. A non-exhaustive list of enhancing ingredients that may optionally be added to the base of the present invention includes flavorants, such as lemon juice, lemon juice powder, reconstituted lemon juice, egg flavor, a lactic acid starter blend, a starter distillate, flavors, and salt; acidulants such as edible acids and edible acid anhydrides, including citric acid, hydrochloric acid, lactic acid, lemon juice powder; cheese; enzyme modified cheese; eggs; edible particulates such as bread crumbs, chopped nuts, meats, dried and fresh fruits, dried and fresh vegetables; herbs and seasonings; cordials and alcoholic beverages such as wine or beer; cocoa liquor; sweeteners such as sugar or corn syrup; artificial sweeteners; and starch. Additionally, colorants such as annatto, beta carotene, turmeric, FD&C dyes, and titanium dioxide may be optionally added to enhance the color of the sauce to be made from the heat stable oil-in-water emulsion of the present invention.

Many of the enhancing ingredients are shear sensitive ingredients that are sensitive to shear forces created by processing equipment such as a mixer or a homogenizer. By shear sensitive ingredients is meant those ingredients which will disintegrate into smaller particles and/or liquify and thereby lose their desired taste, mouthfeel and/or effect in the oil-in-water emulsion when processed through equipment commonly intended to provide shear forces. The shear sensitive ingredients are typically added to the oil-in-water emulsion after the oil-in-water emulsion is processed through a homogenizer and/or a mixer and therefore are not subjected to excessive shear forces.

To prepare the one embodiment of a heat stable oil-in-water emulsion, the aqueous component, preferably cream, is heated to between about a temperature sufficient to make the fat fluid, typically greater than about 104° F., while being agitated. Preferably the cream is heated to between about 130° F. and about 140° F. The cream is heated with methods that do not add moisture to the cream such as but not limited to, a double boiler or a steam jacketed vessel. Water-soluble emulsifiers are optionally added to the aqueous component to promote temperature stability of the oil-in-water emulsion. The cream must be heated to a temperature sufficient to prevent whipping and churning when agitation is applied later in the process. A sufficient temperature for dairy cream is about 100° F.

With the cream heated to the selected temperature and sufficiently agitated, the solids component, such as buttermilk powder, is gradually added to the cream such that the buttermilk powder is substantially uniformly dispersed in the cream. The buttermilk solids component contributes preferably between about 0 and 10 weight percent of the total weight of the oil-in-water emulsion. With the buttermilk solids uniformly dispersed in the aqueous component, stabilizers such as, but not limited to, sodium benzoate and potassium sorbate are optionally added to the cream and buttermilk solids mixture.

The fat containing component, preferably anhydrous milk fat or salted butter, is added to increase the volume and weight percent of the oil component and also to impart a creamier mouth-feel to the sauce made from the oil-in-water emulsion. If water-soluble emulsifiers are present in the aqueous component, fat-soluble emulsifiers may be optionally added to the fat containing component to promote temperature stability of the oil-in-water emulsion. If water-soluble emulsifiers are absent from the aqueous component, fat-soluble emulsifiers are added to the fat containing component. The fat containing component or components preferably contributes between about 5 and 25 weight percent of the total weight of the emulsion and preferably between about 10 and 20 weight percent of the total weight of the emulsion. The anhydrous milk fat is preferably heated to melt a sufficient amount of the fat containing component so that the fat containing component becomes fluid, such as to between about 110° F. and 170° F. and preferably to about 140° F. prior to being added to the aqueous continuous component. Preferably, the heated anhydrous milk fat is added to the mixture of cream and buttermilk solids under agitation to evenly disperse the anhydrous milk fat into the mixture of cream and buttermilk solids.

After the anhydrous milk fat is evenly dispersed into the mixture, colorants and flavorants are optionally added. A flavorant such as a starter lactic blend typically used in the making of cheese and/or an edible acid may be optionally added to the mixture for flavor.

The mixture of at least the cream, the buttermilk solids and the anhydrous milk fat is heated under agitation for a select period of time. Preferably the mixture is maintained at about 150° F. for about 20 minutes to about 30 minutes.

The mixture is then homogenized. Preferably the mixture is homogenized at between about 750 psig and 5000 psig through a single stage homogenizer. Homogenization with a multiple stage homogenizer is also within the scope of the present invention.

The shear sensitive ingredients such as, but not limited to, starches, spices and seasonings, cheese and cheese based products, fruits and vegetables are added to the homogenized mixture and mixed therein until the shear sensitive ingredients are substantially uniformly disbursed therein. The homogenized mixture containing shear sensitive ingredients is then heated to between about 140° F. and about 170° F. and preferably to between about 150° F. and about 160° F. for between about 10 minutes and 60 minutes and preferably between about 20 and 30 minutes. Maintaining the homogenized mixture containing the shear sensitive ingredients at the elevated temperature pasteurizes the homogenous mixture.

The pasteurized mixture can be directly packaged into a desired container and promptly refrigerated. The cooled dairy base is preferably stored under refrigeration to extend shelf life. The cooled dairy base is subsequently useable by full service restaurants as a base for a dairy based sauce.

Alternatively, the pasteurized mixture may be rapidly cooled prior to packaging. An exemplary cooler is a scraped surface heat exchanger that cools the emulsion to a temperature range of between about 40° F. and 70° F. and preferably to a temperature range of 40° F. and 60° F.

With the mixture cooled to the selected temperature, the oil-in-water emulsion has a consistency of a gravy. While the cold filled and hot filled dairy bases have the same compositions, the hot filled emulsion is thinner at elevated temperatures and thicker at refrigerated temperatures.

The restaurant uses the heat stable oil-in-water emulsion as a finished ready-to-use sauce, or as a base to make dairy based sauces such as, but not limited to, alfredo sauce and hollandaise sauce by adding additional ingredients as desired by the restaurant or may use the base containing shear sensitive ingredients as a completed dairy based sauce. However, unlike made from scratch sauces, the oil-in-water emulsion is heat stable and capable of being cycled from refrigerated temperatures to cooking temperatures and back without churning out or creaming. By using the heat stable oil-in-water emulsion as a base for the dairy based sauces requires the employees of the restaurant only to add the ingredients necessary to make the desired sauce and thereby eliminates the need to make the sauce from scratch and the risk of making an unsatisfactory sauce due to an unstable oil-in-water emulsion.

It has been discovered that the process of the present invention and the resulting products manufactured by the process are heat stable, being able to be cycled from a refrigerated temperature to a steam table and back without churning out at lower temperatures or creaming at elevated temperatures. Additionally, the dairy base can be stored in a refrigerated environment for a period of time and when used to produce a dairy based sauce provides the organoleptic properties of a freshly made sauce having shear sensitive ingredients. The following Examples are illustrative only and are not intended to limit the present invention in any way.

### EXAMPLE 1

An alfredo dairy based oil-in-water sauce was produced using the following formulation. Shredded Parmesan cheese, a shear sensitive ingredient, was added to the oil-in-water emulsion after the homogenization process such that the cheese retained its viscous properties in the alfredo sauce.

TABLE 1

| | Approximate |
|---|---|
| Ingredient | Weight percent |
| Cream (40 weight % fat) | 59.6348 |
| Buttermilk powder | 8.2757 |
| Anhydrous milk fat | 9.9470 |
| Starch (Ultra-Sperse ® M) | 0.5000 |
| Emulsifier (Polysorbate 60) | 0.07500 |
| Lecithin | 0.07500 |
| Salt | 1.0000 |
| Sodium benzoate | 0.1000 |
| Potassium sorbate | 0.1250 |
| Starter/Lactic Acid Blend | 0.3175 |
| Shredded Parmesan cheese | 19.9500 |
| | 100.00 |

The cream was heated to about 135° F. in a double boiler. The buttermilk powder was added to the heated cream under agitation. The emulsifier, Polysorbate 60, sodium benzoate and potassium sorbate were also added to the mixture of buttermilk powder and cream under agitation. Salt was added after the emulsifiers and stabilizers were added to the mixture under agitation to form a first intermediate.

The anhydrous milk fat was heated in a separate container to between about 140° F. and about 160° F. such that the milk fat was at the approximate temperature of the first intermediate. When the anhydrous milk fat was heated to about 120° F., lecithin and starch were added to the anhydrous milk fat. The starch, Ultra-Sperse® M, is manufactured by National Starch and Chemical Corporation of Bridgewater, N.J. However, other starches are within the scope of the present invention.

The heated anhydrous milk fat containing the starch and the emulsifier was added to the first intermediate under agitation to evenly disperse the milk fat into the cream and buttermilk thereby forming a second intermediate. The starter distillate and lactic acid blend was added as flavorants to the second intermediate. The second intermediate was heated to about 150° F. under agitation and maintained at 150° F. for about 30 minutes.

The pH of the second intermediate was checked and was found to be within an acceptable range of 5.4-5.5. If the pH was determined to be higher than 5.5, citric acid is to be added to the second intermediate.

The second intermediate was homogenized at about 1500 psig through a single stage homogenizer to form a third intermediate. The shredded Parmesan cheese was stirred into the third intermediate where the mixture of the third intermediate and the Parmesan cheese was subsequently heated to between about 150° F. and 160° F. for about 30 minutes to form the completed dairy based heat stable sauce. The completed dairy based heat stable sauce was promptly refrigerated thereafter.

The Parmesan cheese is sensitive to shear forces created by the homogenizer. Therefore, the Parmesan cheese was added after the homogenization process. While not being bound to theory, it is believed that homogenization at 1500 psig disintegrated the starch, while homogenization at about 750 psig would maintain the starch intact.

The heat stable oil-in-water emulsion had about 41.5 weight percent milk fat and about 37.7 weight percent moisture, and about 51.0 weight percent solids non-fat calculated with the disclosed formula. The heat stable oil-in-water emulsion was found to be repeatedly cyclable from refrigerated temperature to cooking temperatures and back to the refrigerated temperature without churning out or creaming. In addition, the heat stable oil-in-water emulsion demonstrated excellent freeze-thaw stability even when stored frozen at 25° F. for two weeks.

The heat stable oil-in-water emulsion when cooled was thick and formed a mound similar to pudding on a spoon. The emulsion had a buttery flavor and pleasant mouthfeel. The viscosity of the emulsion was determined using a Model # RVDV II+Viscometer manufactured by Brookfield Engineering Labs, Inc. of Middleboro, Mass. The viscosity of the emulsion was determined to be 20,800 cP when the emulsion was heated to 171° F. in a bath with a spindle #5 is rotating at 10 rpm in the emulsion, with the reading taken at 9 seconds to allow the instrument to stabilize.

### EXAMPLE 2

An alfredo dairy based oil-in-water sauce was produced using the following formulation to test the effect of increasing the concentration of buttermilk solids to the dairy based product while eliminating a starch from the dairy based sauce. Shredded Parmesan cheese was added to the oil-in-water emulsion after the homogenization such that the cheese retained its viscous properties.

TABLE 2

| | Approximate |
|---|---|
| Ingredient | Weight percent |
| Cream (40 weight % fat) | 55.7800 |
| Buttermilk powder | 9.7884 |
| Anhydrous milk fat | 9.3000 |
| Emulsifier (Polysorbate) | 0.0750 |
| Lecithin | 0.0750 |
| Salt | 1.0000 |
| Sodium benzoate | 0.1000 |
| Potassium sorbate | 0.1250 |
| Starter distillate | 0.3175 |
| Water | 3.4891 |
| Shredded Parmesan cheese | 19.9500 |
| | 100.00 |

The alfredo sauce was produced using the same procedure as described in Example 1 where the water was mixed into the cream prior to heating. The fat content was reduced to 39.3 weight percent, moisture or water content was increased to 39.2 weight percent while the solids non-fat were increased to 37.5 weight percent with the increased percentage of buttermilk powder. Also the second intermediate was homogenized at 2500 psig instead of 1500 psig as disclosed in Example 1.

The heat stable oil-in-water emulsion was found to be repeatedly cyclable from refrigerated temperature to cooking temperatures and back to the refrigerated temperature without churning out or creaming. The viscosity of the oil-in-water emulsion was determined to be 5,340 cP using the testing method disclosed in Example 1. The heat stable oil-in-water emulsion was found to have a sweat taste and also had a gritty texture.

### EXAMPLE 3

An alfredo dairy based oil-in-water sauce was produced using the following formulation. Shredded Parmesan cheese was added to the oil-in-water emulsion after the homogenization such that the cheese retained its viscous properties.

TABLE 3

| | Approximate |
|---|---|
| Ingredient | Weight percent |
| Cream (40 weight % fat) | 51.0600 |
| Buttermilk powder | 15.0000 |
| Anhydrous milk fat | 8.5200 |
| Emulsifier (Polysorbate) | 0.0750 |
| Lecithin | 0.0750 |
| Salt | 1.0000 |
| Sodium benzoate | 0.1000 |
| Potassium sorbate | 0.1250 |
| Water | 3.7775 |
| Starter distillate | 0.3175 |
| Shredded Parmesan cheese | 19.9500 |
| | 100.00 |

The alfredo sauce was produced using the same procedure as described in Example 2. The fat content was reduced to 36.9 weight percent, moisture or water content was decreased to 37.1 weight percent while the solids nonfat were increased to 43.1 weight percent with the increased percentage of buttermilk powder.

The heat stable oil-in-water emulsion was found to be repeatedly cyclable from refrigerated temperature to cooking temperatures and back to the refrigerated temperature without churning out or creaming. The viscosity of the oil-in-water emulsion was determined to be 19,660 cp using the testing method disclosed in Example 1. The heat stable oil-in-water emulsion was found to have a sweat and astringent taste and also had a powdery and gritty texture.

### EXAMPLES 4-9

Examples 4-9 were conducted to determine the effectiveness of whey protein concentrate as a substitute for buttermilk powder in the heat stable oil-in-water emulsion for use as an alfredo sauce. Also, the effect of different concentrations of starch added after the second intermediate was homogenized was evaluated.

TABLE 4

| | Ex. 4 | Ex. 5 | Ex. 6 | Ex. 7 | Ex. 8 | Ex. 9 |
|---|---|---|---|---|---|---|
| Ingredient | Wt. % | Wt. % | Wt. % | Wt. % | Wt. % | Wt. % |
| Cream (40 weight % fat | 55.7800 | 55.7800 | 55.7800 | 55.7800 | 55.7800 | 55.7800 |
| WPC 80 | 2.0000 | 2.0000 | 2.0000 | 2.0000 | 2.0000 | 2.0000 |
| Anhydrous milk fat | 9.3000 | 9.3000 | 9.3000 | 9.3000 | 9.3000 | 9.3000 |
| Water | 11.2775 | 10.9775 | 10.7775 | 9.7775 | 10.2775 | 10.5275 |
| Starch (Ultra-Sperse ® M) | 0.0000 | 0.3000 | 0.5000 | 1.5000 | 1.0000 | 0.7500 |
| Emulsifier (Polysorbate60) | 0.0750 | 0.0750 | 0.0750 | 0.0750 | 0.0750 | 0.0750 |
| Lecithin | 0.0750 | 0.0750 | 0.0750 | 0.0750 | 0.0750 | 0.0750 |
| Salt | 1.0000 | 1.0000 | 1.0000 | 1.0000 | 1.0000 | 1.0000 |
| Sodium Benzoate | 0.1000 | 0.1000 | 0.1000 | 0.1000 | 0.1000 | 0.1000 |
| Potassium sorbate | 0.1250 | 0.1250 | 0.1250 | 0.1250 | 0.1250 | 0.1250 |
| Starter/Lactic Blend | 0.3175 | 0.3175 | 0.3175 | 0.3175 | 0.3175 | 0.3175 |
| Shredded Parm. Cheese | 19.9500 | 19.9500 | 19.9500 | 19.9500 | 19.9500 | 19.9500 |
| | 100.00 | 100.00 | 100.00 | 100.00 | 100.00 | 100.00 |
| Weight % water | 41.83 | 41.53 | 41.33 | 40.33 | 40.83 | 41.08 |
| Weight % fat | 37.25 | 37.25 | 37.25 | 37.25 | 37.25 | 37.25 |
| Weight % SNF | 24.40 | 24.94 | 25.30 | 26.62 | 26.21 | 25.75 |

Each of the formulations in Examples 4-9 were prepared using a method similar to that used to prepare the heat stable oil-in-water emulsion in Example 1. Whey protein concentrate having 80 weight percent weight protein (WPC 80) was substituted for the buttermilk powder. The starch, Ultra-Sperse® M, was mixed into the shredded Parmesan cheese which was added to the emulsion after the homogenization step. The cheese and the starch are sensitive to shear and therefore were added after the homogenization step.

The formulation in Example 4 was homogenized at 2500 psig while the formulations in Examples 5-9 were homogenized at 1000 psig. The viscosity of the completed alfredo sauces are tabulated in the following table. The viscosities of the emulsions was determined using the Model # RVDV II+viscometer manufactured by Brookfield Engineering Labs, Inc. of Middleboro, Mass. The viscocities were determined after heating the emulsion to about 170° F. and rotating the spindle at about 20 rpm for about 9 seconds.

TABLE 5

| Example | Wt. % | PSIG | | |
|---|---|---|---|---|
| # | Starch | homogenization | CP | Spindle & Speed |
| 4 | 0.0 | 2500 | 950 | #3 @ 20 rpm |
| 5 | 0.3 | 1000 | 956 | #3 @ 20 rpm |
| 6 | 0.5 | 1000 | 1128 | #3 @ 20 rpm |
| 7 | 1.5 | 1000 | 26800 | #5 @ 10 rpm |
| 8 | 1.0 | 1000 | n/a* | |
| 9 | 0.75 | 1000 | 2310 | #3 @ 20 rpm |

Alfredo sauce has an acceptable appearance, taste and thickness when the viscosity is between about 2000 cP and about 800 cP. From examples 4-9 it was concluded that a formulation containing about 2.0 weight percent of an WPC80 required less than 1.0 weight percent of starch that is added after the homogenization step. A more preferred weight percentage of starch is about 0.75 weight percent.

Additional shear sensitive ingredients can be added to the oil-in-water heat stable emulsion after the homogenization step. To accentuate the taste of the formulation of Example 9, 0.1 weight percent of pureed garlic manufactured by Pacific Choice Brands of Fresno, Calif. was added along with 0.02 weight percent of a ground black pepper having ingredient # 945003 which is manufactured by McCormick & Company, Inc. of Sparks, Md. The garlic and black pepper favorably added to the taste of the alfredo sauce.

The formulations in Examples 4-9 having the WPC 80 had a more buttery taste and did not have the astringent, sweet and powdery taste that was caused by the buttermilk powder. However, it was determined that the viscosity of the formulations having the WPC 80 will increase when the WPC denatures due to excessive heat. The formulation in Example 4 was heated until the WPC denatured at which time the viscosity was tested to be 1706 cP, an increase of almost double from the emulsion where the whey protein was not denatured.

### EXAMPLE 10

An experiment was completed to evaluate the effect of the use of xanthan gum in combination with a starch to improve the viscosity characteristics of the heat stable oil-in-water emulsion for use as an alfredo sauce. The use of butter as an ingredient was also evaluated in this experiment. The formulation of example 10 follows in Table 6.

TABLE 6

| | Approximate |
|---|---|
| Ingredient | Weight percent |
| Cream (40 weight % fat) | 35.9300 |
| Buttermilk powder | 4.3952 |
| Anhydrous milk fat | 7.9337 |
| Water | 16.5243 |
| Salted butter | 15.4853 |
| Starch (Ultra-Sperse ® M) | 0.2500 |
| Xanthan gum¹ | 0.0350 |
| Emulsifier (Polysorbate | 0.0800 |
| 60) | |
| Lecithin | 0.0800 |
| Salt | 0.1627 |
| Sodium benzoate | 0.1000 |
| Potassium sorbate | 0.1250 |
| Black pepper | 0.0901 |
| Garlic (pureed) | 0.5350 |
| Shredded Parmesan cheese | 18.2737 |
| | 100.00 |

¹Keltrol 521 manufactured by manufactured by CP Kelco, Inc. of Atlanta, Georgia which is also used in the following examples containing zanthan gum.

The alfredo sauce was produced using the same procedure as described in Example 1. The alfredo sauce had about 42.47 weight % moisture, about 39.99 weight % fat and about 25.9 weight % SNF. Also the second intermediate was homogenized at 750 psig instead of 1500 psig as disclosed in Example 1. The xanthan gum was added to the cream along with the BMP, salt, potassium sorbate and sodium benzoate.

The garlic was sauteed in about 6.0 weight percent of the butter ingredient. The sauteed garlic and butter were added with the other shear sensitive ingredients including cheese, starch and ground black pepper that were added to the oil-in-water emulsion after the homogenization process since each of these ingredients is sensitive to shear forces.

The heat stable oil-in-water emulsion was found to be repeatedly cyclable from refrigerated temperature to cooking temperatures and back to the refrigerated temperature without churning out or creaming. The viscosity of the oil-in-water emulsion was determined to be 5,340 cp using the testing method disclosed in Example 1.

Further, the shear sensitive ingredients remained dispersed through the emulsion and did not separate from the emulsion when cooled and refrigerated. However, the amounts of the shear sensitive ingredients such as ground black pepper and garlic can be increased or eliminated depending upon the taste preference of the diner while still practicing the present invention.

### EXAMPLES 11-14

A series of experiments were completed to evaluate the effect of the use of Simplesse 100 fat substitute as a replacement for buttermilk powder on the heat stable oil-in-water emulsion for use as an alfredo sauce. The use of butter as an ingredient was also evaluated in this experiment. The formulation of Examples 11-14 follows in Table 7.

TABLE 7

| | Ex. 11 | Ex. 12 | Ex. 13 | Ex. 14 |
|---|---|---|---|---|
| Ingredient | Wt. % | Wt. % | Wt. % | Wt. % |
| Cream (40 weight % fat) | 37.7936 | 37.2076 | 38.5898 | 38.5898 |
| Simplesse 100 | 2.9301 | 2.0000 | 4.0000 | 3.8000 |
| Salted butter | 13.4853 | 13.4853 | 5.0000 | 5.0000 |
| Anhydrous milk fat | 6.0701 | 6.0701 | 6.0701 | 6.0701 |
| Water | 18.5243 | 20.0405 | 25.0000 | 25.0700 |
| Starch (Ultra-Sperse 60) | 0.2500 | 0.2500 | 0.0000 | 0.0000 |
| Emulsifier | 0.0800 | 0.0800 | 0.0800 | 0.0800 |
| (Polysorbate 60) | | | | |
| Lecithin | 0.0800 | 0.0800 | 0.0800 | 0.0800 |
| Salt | 0.1627 | 0.1627 | 0.1800 | 0.3600 |
| Sodium benzoate | 0.1000 | 0.1000 | 0.1000 | 0.1000 |
| Potassium sorbate | 0.1250 | 0.1250 | 0.1250 | 0.1250 |
| Xanthan gum | 0.0350 | 0.0350 | 0.1500 | 0.1000 |
| Black pepper | 0.0901 | 0.0901 | 0.0901 | 0.0901 |
| Garlic (puree) | 0.0000 | 0.0000 | 0.5350 | 0.5350 |
| Shredded Parm. Cheese | 20.2737 | 20.2737 | 20.0000 | 20.0000 |
| | 100.00 | 100.00 | 100.00 | 100.00 |
| Weight % moisture | 45.46 | 46.67 | 50.93 | 51.00 |
| Weight % fat | 33.79 | 33.72 | 31.37 | 31.09 |
| Weight % SNF | 24.40 | 21.88 | 22.29 | 22.26 |

The alfredo sauce was produced using the same procedure as described in Example 10. The second intermediate was homogenized at 750 similar to the homogenization process in Example 10. The Simplesse 100 was added to the cream along with the xanthan gum, salt, potassium sorbate and sodium benzoate.

In Examples 13 and 14, the garlic was sauteed in butter in a manner similar to that disclosed in Example 10. The sauteed garlic and butter were added with the other shear sensitive ingredients including cheese, starch and ground black pepper that were added to the oil-in-water emulsion after the homogenization process since each of these ingredients is sensitive to shear forces. The heat stable oil-in-water emulsion was found to be repeatedly cyclable from refrigerated temperature to cooking temperatures and back to the refrigerated temperature without churning out or creaming.

The Brookfield viscosity of the oil-in-water emulsion was determined to be 6,620 and 4,980 cP for Examples 13 and 14. The viscosity of Examples 13 and 14 were determined to be 7 and 7.5 and 9 and 9.5 at the leading edge and the trailing edge of the blade, respectively, using a Bostwick consistometer manufactured by CSC Scientific Co., Inc. of Fairfax, Va.

Further, the shear sensitive ingredients remained dispersed through the emulsion and did not separate from the emulsion when cooled and refrigerated. However, the amounts of the shear sensitive ingredients such as ground black pepper and garlic can be increased or eliminated depending upon the taste preference of the diner while still practicing the present invention.

### EXAMPLE 15-16

Additional formulations of the oil-in-water emulsion with shear sensitive ingredients were prepared with white sauce powders. Flavorants were added to the oil-in-water emulsion in Example 15 to enhance the flavor of the sauce when heated. The formulation of Examples 15-16 follows in Table 8.

TABLE 8

| | Ex. 15 | Ex. 16 |
|---|---|---|
| Ingredient | Wt. % | Wt. % |
| Cream (40 weight % fat) | 28.0436 | 33.3986 |
| Simplesse 100 | 3.0000 | 2.1600 |
| Salted butter | 15.5309 | 15.5309 |
| White Sauce base | 3.4750¹ | 4.3000⁴ |
| Water | 25.9004 | 25.9004 |
| Butterbuds 32X² | 0.4100 | 0.0000 |
| Starch (Ultra-Sperse M) | 0.2500 | 0.2500 |
| Emulsifier (Polysorbate 60) | 0.0800 | 0.0800 |
| Lecithin | 0.0800 | 0.0800 |
| Salt | 0.2000 | 0.3700 |
| Sodium benzoate | 0.1000 | 0.1000 |
| Potassium sorbate | 0.1000 | 0.1000 |
| Xanthan gum | 0.0500 | 0.0500 |
| Butter flavor³ | 0.1000 | 0.0000 |
| Lactic Acid (885) | 0.0900 | 0.0900 |
| Black pepper | 0.0901 | 0.0901 |
| Shredded Parm. Cheese | 22.5000 | 17.5000 |
| | 100.0 | 100.0 |
| Weight % water | 48.57 | 50.83 |
| Weight % fat | 31.58 | 30.81 |
| Weight % SNF | 22.62 | 24.29 |

¹White sauce base containing no flour manufactured by McCormick & Company, Inc. of Sparks, MD.
²Manufactured by Cumberland Packing Company of Brooklyn, NY.
³Natural Butter flavor #4430 manufactured by Edlong Dairy Flavors of Elk Grove Village, IL.
⁴White sauce base containing flour manufactured by McCormick & Company, Inc. of Sparks, MD.

The alfredo sauce was produced using the same procedure as described in Example 10. The second intermediate was homogenized at 750 psig similar to the homogenization process in Example 10. The Simplesse 100 was added to the cream along with the xanthan gum, salt, potassium sorbate and sodium benzoate. The flourless white sauce base, flavorants, Butterbuds 32X, natural butter flavoring and lactic acid were added the cream to Example 15 prior to the second intermediate being homogenized. The shear sensitive ingredients mixed into the homogenized intermediate included the cheese, starch and pepper.

The white sauce base in Example 16 was added to the butter and then the butter and white sauce base were heated to about 170° F. and then mixed into the cream at a temperature of about 140° F. Both of the versions provided a rich creamy texture and buttery taste which was satisfactory for a full service restaurant. The heat stable oil-in-water emulsion was found to be repeatedly cyclable from refrigerated temperature to cooking temperatures and back to the refrigerated temperature without churning out or creaming.

### EXAMPLE 17

An alfredo sauce was made with the recipe of Example 16 using a modification of the method previously disclosed. The salted butter is heated to between about 140° F. and 160° F. Emulsifiers and the white sauce base with flour are added to the heated butter. The heated butter with the emulsifiers and the white sauce base are heated to boiling at about 222° F. for about 4 minutes.

The cream component was processed via the method disclosed in Example 16 However, when the butter was added to the cream the temperature of the intermediate was about 181° F. The intermediate was homogenized at about 750 psig. The shear sensitive ingredients including cheese, starch and pepper were added to the homogenized intermediate and the mixture was heated to between about 155° F. and 160° F. for about 30 minutes after which time the mixture was promptly refrigerated.

The heat stable oil-in-water emulsion was found to be repeatedly cyclable from refrigerated temperature to cooking temperatures and back to the refrigerated temperature without churning out or creaming. The alfredo sauce of Example 17 had a cooked, rich, cheesy flavor that was not bitter. The cheesy flavor did not have Parmesan cheese tones.

### EXAMPLE 18

An additional formulation of the oil-in-water emulsion with shear sensitive ingredients was prepared with a white sauce powder without flour. The formulation of Example 18 follows in Table 9.

TABLE 9

| | Ex. 18 |
|---|---|
| Ingredient | Wt. % |
| Cream (40 weight % fat | 33.4936 |
| Simplesse 100 | 3.0000 |
| Salted butter | 15.6309 |
| White Sauce base | 3.4750¹ |
| Water | 25.9004 |
| Emulsifier (Polysorbate 60) | 0.0800 |
| Lecithin | 0.0800 |
| Salt | 0.4100 |
| Sodium benzoate | 0.1000 |
| Potassium sorbate | 0.1000 |
| Xanthan gum | 0.0500 |
| Lactic Acid (88%) | 0.0900 |
| Black pepper | 0.0901 |
| Shredded Parm. Cheese | 17.5000 |
| | 100.00 |
| Weight % water | 50.25 |
| Weight % fat | 31.01 |
| Weight % SNF | 24.20 |

¹White sauce base containing no flour manufactured by McCormick & Company, Inc. of Sparks, MD

The salted butter was heated to between about 140° F. and 160° F. Emulsifiers and the white sauce base without flour were added to the heated butter. The heated butter with the emulsifiers and the white sauce base are heated to about 167° F.

The cream was heated to about 120° F. and the Simplesse, salt, sodium benzoate, potassium sorbate, zanthan gum are added to the cream as a dry blend while the cream is being vigorously whisked. When the cream was at about 140° F. the butter was transferred to the cream and mixed therein with a blender or immersion blender. The cream and butter mixture was heated to about 155° F. and then homogenized at about 750 psig in a single stage homogenizer. The shear sensitive ingredients, Parmesan cheese and pepper were stirred into the homogenized intermediate and the mixture is heated to between about 155° F. and about 160° F. for about 30 minutes. After heating the mixture for about 30 minutes the sauce was completed and promptly refrigerated.

The heat stable oil-in-water emulsion was found to be repeatedly cyclable from refrigerated temperature to cooking temperatures and back to the refrigerated temperature without churning out or creaming. The alfredo sauce of Example 18 had a cooked, rich, cheesy flavor and was the equivalent of a made from scratch alfredo sauce.

### EXAMPLE 19

A reduced heavy cream sauce having roasted red bell peppers therein was produced with the method of the present invention. The formulation of the reduced heavy cream sauce having roasted red bell peppers therein is as follows in Table 10.

TABLE 10

| | Ex. 19 |
|---|---|
| Ingredient | Wt. % |
| Cream (42 wt. % fat) | 56.6500 |
| Water | 4.7965 |
| Buttermilk powder | 8.2235 |
| Sweet whey | 0.5000 |
| Sodium caseinate | 0.1500 |
| Dried cream Extract1 | 0.3000 |
| Sodium Benzoate | 0.1000 |
| Potassium sorbate | 0.1250 |
| Nonfat Dairy Milk | 0.0050 |
| X-grade LH | |
| Unsalted butter | 29.0000 |
| Tween 60 | 0.0750 |
| Lecithin | 0.0750 |
| | 100.00 |

The butter was heated to about 140° F. and the polysorbate (Tween 60) and lecithin were mixed into the melted butter. The buttermilk powder, sodium caseinate, Nonfat dairy milk powder, sodium benzoate and potassium sorbate were combined and uniformly mixed together. The cream and water were mixed together and heated to about 100° F. The mixed powders were added to the cream with an immersion blender. The butter component was added to the cream component in a steady stream using the immersion blender to form an intermediate that was heated to about 155° F. of about 30 minutes. Citric acid can be optionally added to adjust the pH to between about 5.1 and about 5.5.

The intermediate was homogenized with a single stage homogenizer at about 750 psig. Shear sensitive diced and pureed red bell peppers were added to the homogenized mixture and stirred therein. The mixture with the red bell peppers was heated to about 160° F. for about 30 minutes and was subsequently filled into tubs and cooled.

The heat stable oil-in-water emulsion had contained about 37.85 weight % water, about 45.72 weight % fat, and 43.37 weight % SNF. The heat stable oil-in-water emulsion was found to be repeatedly cyclable from refrigerated temperature to cooking temperatures and back to the refrigerated temperature without churning out or creaming. This example shows that any shear sensitive ingredient can be added to the heat stable oil-in-water emulsion of the present invention and can be retained therein for extended periods of times without separating from the oil-in-water emulsion.

Although the present invention has been described with reference to preferred embodiments, workers skilled in the art will recognize that changes may be made in form and detail without departing from the spirit and scope of the invention.

1. A method of forming a heat stable oil-in-water emulsion comprising:
providing a selected amount of an aqueous component;
heating the aqueous component to a temperature sufficient to avoid whipping and churning of the aqueous component when shear is applied;
adding a selected amount of a solids component to the aqueous component under agitation to form a first intermediate;
heating a selected amount of a fat containing component to a temperature sufficient to melt a sufficient amount of the fat containing component so that the fat containing component becomes fluid;
adding an emulsifier either to the aqueous component or to the fat containing component or both;
adding the heated fat containing component to the first intermediate with sufficient agitation to disperse the added fat containing component in the first intermediate to form a second intermediate;
homogenizing the second intermediate at between about 250 psig and 5000 psig to form a third intermediate comprising at least 20 weight percent fat; and
adding at least one shear sensitive ingredient to the third intermediate to form the heat stable oil-in-water emulsion.

2. The method of claim 1 and wherein the fat is heated to between about 100° F. and 150° F.

3. The method of claim 1 and wherein the second intermediate is heated for a selected period of time.

4. The method of claim 3 and wherein the second intermediate is homogenized at a temperature sufficient to maintain the fat containing component in a fluid condition.

5. The method of claim 4 and further comprising pasteurizing the heat stable oil-in-water emulsion containing the at least one shear sensitive ingredient.

6. The method of claim 1 wherein the aqueous component comprises a cream.

7. The method of claim 1 and wherein the aqueous component comprises about 40 weight percent fat.

8. The method of claim 1 and wherein the solids component comprises buttermilk solids.

9. The method of claim 8 and wherein the selected amount of buttermilk solids component is between about 2 and 10 weight percent of the heat stable oil-in-water emulsion.

10. The method of claim 1 and wherein the solids component comprises whey solids.

11. The method of claim 10 and wherein the selected amount of whey solids component is between about 2 and 10 weight percent of the heat stable oil-in-water emulsion.

12. The method of claim 1 and wherein the solids component comprises a fat substitute.

13. The method of claim 12 and wherein the selected amount of the fat substitute comprises between about 0.5 and 10 weight percent of the heat stable oil-in-water emulsion.

14. The method of claim 1 and wherein the fat containing component comprises milk fat.

15. The method of claim 1 and wherein the fat containing component comprises anhydrous milk fat.

16. The method of claim 15 and wherein the selected amount of anhydrous milk fat is an amount sufficient to provide a heat-stable oil-in-water emulsion comprising at least about 20% fat.

17. The method of claim 15 and wherein the selected amount of anhydrous milk fat is an amount sufficient to provide a heat-stable oil-in-water emulsion comprising at least about 30% fat.

18. The method of claim 1 and wherein the fat containing component comprises butter.

19. The method of claim 20 and wherein the selected amount of butter is above about 5 weight percent.

20. The method of claim 1 and wherein the shear sensitive ingredient comprises a cheese.

21. The method of claim 1 and wherein the shear sensitive ingredient comprises a starch.

22. The method of claim 1 and wherein the shear sensitive ingredient comprises an herb or a seasoning.

23. The method of claim 1 and wherein the shear sensitive ingredient comprises garlic.

24. The method of claim 1 and further comprising heating the heat stable oil-in-water emulsion containing shear sensitive ingredients to between about 150° F. and about 160° F. for between about 20 minutes and 30 minutes.

25. A sauce base, the sauce base comprising:
an aqueous component wherein the aqueous component comprises more than 50 weight percent moisture;
a solids component wherein the solids component comprises protein; and
a fat containing component wherein the fat containing component increases a fat concentration of the base to greater than 20 weight percent;
an emulsifier wherein the emulsifier is added to the aqueous component or to the milk fat containing component or both and wherein the aqueous component, the solids component the fat containing component and the emulsifier are added together such that the protein concentration of the base is in a range of greater than 3 weight percent and less than 10 weight percent and wherein when the base is homogenized; and
at least one shear sensitive ingredient added to the homogenized base such that when the base and the at least one shear sensitive ingredient packages, the base comprises an oil-in-water emulsion that is storable, heat stable and usable for a dairy based sauce having the organoleptic properties of a made from scratch dairy based sauce.

26. The sauce base of claim 25 and wherein the fat is heated to between about 100° F. and 150° F.

27. The sauce base of claim 25 and wherein the second intermediate is heated for a selected period of time

28. The sauce base of claim 27 and wherein the second intermediate is homogenized at a temperature sufficient to maintain the fat containing component in a fluid condition.

29. The sauce base of claim 25 and wherein the homogenized base and the at least one shear sensitive ingredient are pasteurized.

30. The base of claim 25 and wherein the base comprises an oil-in-water emulsion that is storable.

31. The base of claim 25 and wherein the base comprises an oil-in-water emulsion that is heat stable.

32. The base of claim 25 and wherein the base comprises an oil-in-water emulsion that is freeze-thaw stable.

33. The base of claim 25 and wherein the base comprises an oil-in-water emulsion that is freeze-thaw stable.

34. The base of claim 25 and wherein a fat concentration of the base comprises between about 20 weight percent and 96 weight percent of the base.

35. The base of claim 25 and wherein a moisture concentration of the base comprises between about 35 weight percent and 50 weight percent of the base.

36. The base of claim 25 and wherein a solids non-fat content of the base is greater than three weight percent and less than or equal to 30 weight percent of the base.

37. The base of claim 25 and wherein the aqueous component comprises a cream.

38. The base of claim 37 and wherein the cream comprises about 40 weight percent fat.

40. The base of claim 25 and wherein the solids component comprises buttermilk solids.

41. The base of claim 40 and wherein the buttermilk solids comprise between about 3 weight percent and 10 weight percent.

42. The base of claim 25 and wherein the solids component comprises whey solids.

43. The base of claim 42 and wherein the selected amount of whey solids component is between about 3 and 10 weight percent of the heat stable oil-in-water emulsion.

44. The base of claim 25 and wherein the fat containing component comprises butter.

45. The base of claim 44 and wherein the sum of the vegetable oil and the butter comprises above about 5 weight percent of the total weight of the base.

46. The base of claim 25 and further comprising stabilizers.

47. The base of claim 25 and further comprising enhancing ingredients.

48. The base of claim 25 and further comprising enhancing ingredients added to the aqueous component.

49. The base of claim 25 and further comprising enhancing ingredients added to the fat containing component.

50. The base of claim 25 and wherein the shear sensitive ingredient comprises cheese.

51. The base of claim 50 and wherein the cheese comprises between about 10 weight percent and 25 weight percent of the weight of the oil-in-water emulsion.

52. The base of claim 25 and wherein the shear sensitive ingredient comprises a starch.

53. The base of claim 25 and wherein the shear sensitive ingredient comprises an herb or a seasoning.

54. The base of claim 25 and wherein the shear sensitive ingredient comprises garlic.

55. The base of claim 25 and wherein the shear sensitive ingredient comprises a fruit or a vegetable.

56. The base of claim 25 and wherein the shear sensitive ingredient comprises a bell pepper.
